(19) United States
(12) Patent Application Publication
(10) Pub. No.: US 2026/0312988 A1
(43) Pub. Date: Oct. 8, 2026

(54) DNS REQUEST INJECTION TO DEFEAT TIMING-BASED DNS EXFILTRATION

(71) Applicant: Palo Alto Networks, Inc., Santa Clara, CA (US)

(72) Inventors: Ruian Duan, Fremont, CA (US); Daiping Liu, Santa Clara, CA (US); Shu Wang, San Jose, CA (US); Fan Fei, Pleasanton, CA (US)

(21) Appl. No.: 19/172,950

(22) Filed: Apr. 8, 2025

(51) Int. Cl. H04L 9/40

(52) U.S. Cl. CPC H04L 63/1466

(57) ABSTRACT

Defenses against covert timing-based DNS tunneling attacks have been created that inject noise into the covert timing channel to corrupt potential data infiltration or potential data exfiltration without disrupting legitimate DNS communications. After filtering out trustworthy domains, time intervals between DNS queries per domain are observed and a minimum time interval determined per domain. During in-line network traffic monitoring, time after each DNS request per domain is measured for lapse of the minimum time interval. After each determination that the minimum time interval for a domain has expired since a DNS query for the domain has been transmitted, a DNS query for the domain is non-deterministically injected. For potential data infiltration using the covert timing channel, values of the time-to-live (TTL) indicated in DNS responses are randomized with a ceiling of the TTL specified in the DNS record.

### BACKGROUND

The disclosure generally relates to defending against cyberattacks by DNS tunneling (e.g., CPC subclass H04L 63).

In the publication “Mitigate DNS Infrastructure Tampering,” the Cybersecurity and Infrastructure Security Agency (CISA) states that cybersecurity organizations detected an increase in abuse of the Domain Name System (DNS) infrastructure in late 2018. In 2019-Jan.-22, CISA published an emergency directive with required actions related to the increasing abuse of DNS infrastructure. Malicious actors have abused DNS with DNS tunneling for decades. For DNS tunneling, a malicious actor registers a domain and specifies for the domain a name server controlled by the malicious actor. After compromising a client, the malicious actor tunnels malware and other data within the DNS requests and responses. The DNS communications effectively become a command-and-control (C2) channel. Responses from compromised clients operate as heartbeats. Data can be encoded in the qname field of DNS requests for data exfiltration and data (i.e., commands or malware) can be encoded into rdata fields of DNS responses for data infiltration.

### BRIEF DESCRIPTION OF THE DRAWINGS

Embodiments of the disclosure may be better understood by referencing the accompanying drawings.

FIG. 1 is a diagram of a firewall defending against a timing-based DNS tunneling data exfiltration attack.

FIG. 2 is a diagram of a firewall defending against a timing-based DNS tunneling data infiltration attack.

FIG. 3 is a flowchart of example operations for defending against data exfiltration by covert timing-based DNS tunneling.

FIG. 4 is a flowchart of example operations for defending against data infiltration by covert timing-based DNS tunneling.

FIG. 5 is a diagram of a firewall defending against a timing-based relayed DNS tunneling data infiltration attack.

FIG. 6 is a flowchart of example operations for defending against data infiltration by covert timing-based relayed DNS tunneling.

FIG. 7 depicts an example computer system with security against timing-based DNS tunneling attacks.

### DESCRIPTION

The description that follows includes example systems, methods, techniques, and program flows to aid in understanding the disclosure and not to limit claim scope.

Well-known instruction instances, protocols, structures, and techniques have not been shown in detail for conciseness.

### Terminology

It is common for the term root domain to be used imprecisely to refer to a registered domain. The common use is imprecise because root domain refers to the highest hierarchical level of the Internet above the top-level domain. However, root domain is commonly used to refer to the part of a fully qualified domain name (FQDN) below effective top-level domains (eTLD). The term eTLD extends TLD to encompass a public suffix that includes one or more components below the TLD under which domain names can be directly registered, such as the eTLD “.co.kr” or “.pvt.k12.ma.us.” This description uses “root domain” as used commonly to refer to the domain name component below and including the eTLD.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed

### Overview

Abuse of DNS has evolved to more covert DNS tunneling that utilizes the timing channel for implicit data infiltration and exfiltration. Instead of explicitly encoding data into fields of DNS communications that could be detected by a security appliance or service (e.g., firewall or security service), this abuse of DNS leverages the timing of DNS requests from a compromised client for data exfiltration and timing of DNS from a malicious actor controlled name server (“attacker name server”) for data infiltration.

Defenses against these covert timing-based attacks have been created that inject noise into the covert timing channel of DNS communications to corrupt potential data infiltration or potential data exfiltration without disrupting legitimate DNS communications. After filtering out trustworthy domains, time intervals between DNS queries per domain are observed and a minimum time interval determined per domain. During in-line network traffic monitoring, time after each DNS request per domain is measured for lapse or expiration of the minimum time interval. After each determination that the minimum time interval for a domain has expired since a DNS query for the domain has been transmitted, a DNS query for the domain is non-deterministically injected. For potential data infiltration using the covert timing channel, values of the time-to-live (TTL) indicated in DNS responses are randomized with a ceiling of the TTL specified in the DNS record. Thus, a cached DNS response can be delivered sooner than anticipated by the attacker name server and can corrupt the data infiltration.

A variation of the covert timing-based DNS tunneling attack relays data via a reputable service. Protocols such as Simple Mail Transfer Protocol (SMTP), Quick User Datagram Protocol (UDP) Internet Protocol (QUIC), and HyperText Transfer Protocol (HTTP), can be abused to cause servers of reputable services to interact with an attacker name server. A compromised client inserts a hostname into a header field, for example, that causes the reputable service to query the attacker name server to resolve the hostname. Using this hidden resolution path, malicious actors can evade countermeasures that inspect DNS traffic for malicious domains. After the compromised client and the attacker name server interact to measure observed round trip times (RTTs) when the attacker name server responds and RTTs when the attacker name server maximally delays responding, the compromised client can determine how to interpret implicitly encoded data in the timing channel. To defend against this data infiltration by relayed DNS tunneling, randomization is introduced into the covert timing channel to corrupt the commands or malware being implicitly transmitted from the attacker name server. For each domain that has not been filtered out as trustworthy, minimum and maximum latencies are determined from observed RTTs among request and response pairs for network traffic. To introduce randomization into the timing channel, a response to a request with a likely trigger for relayed DNS tunneling is delayed for a randomized time that falls within the minimum and maximum latencies determined for a corresponding domain.

### Example Illustrations

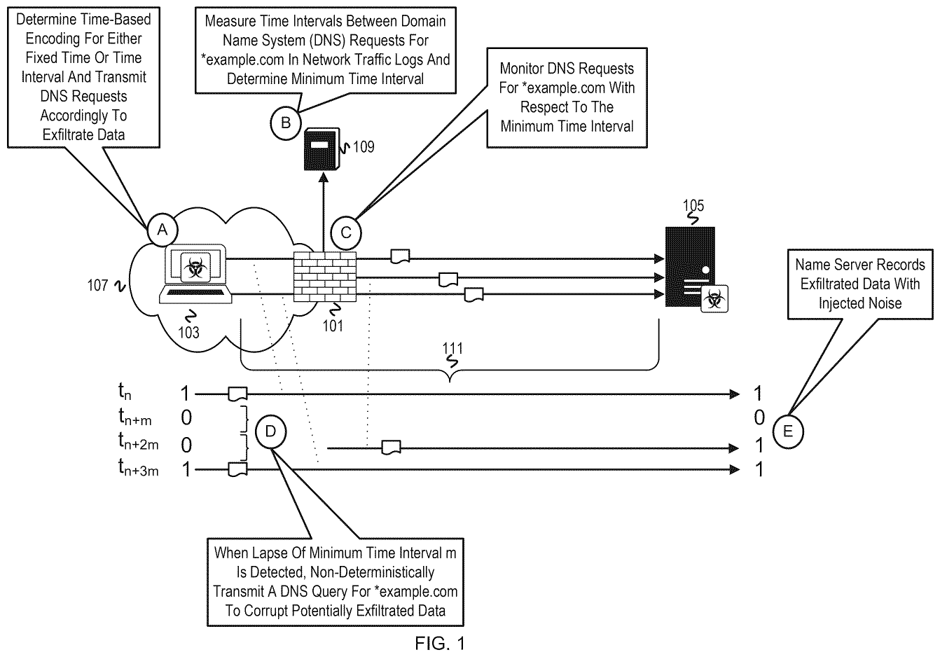

FIG. 1 is a diagram of a firewall defending against a timing-based DNS tunneling data exfiltration attack. FIG. 1 depicts a compromised client 103 in a network 107 protected by a firewall 101. The compromised client 103 is attempting to exfiltrate data by implicitly encoding the data based on timing of requests for a root domain name example. com to an attacker name server 105 that has been established to respond to DNS requests for example. com. This example illustration presumes summarization by root name, but implementations can monitor by FQDN.

FIG. 1 is annotated with a series of letters A-E representing stages of operations, each stage corresponding to one or more operations. Stages B, C, D and E each encompasses multiple operations that can overlap in time with operations of other stages. Although these stages are ordered for this example, the stages illustrate one example to aid in understanding this disclosure and should not be used to limit the claims. Subject matter falling within the scope of the claims can vary from what is illustrated.

At stage A, the compromised client 103 determines whether data will be encoded according to a fixed time scheme or a time interval scheme. This may be programmed in the command and control (C2) malware that has compromised the compromised client 103. For either scheme, the compromised client 103 will interact with the attacker name server 105 to determine RTTs. With sufficient RTTs, the compromised client 103 can calculate the bounds of time channel encoding. Assuming RTT measured in seconds, the maximum RTT is the bound for encoding 1-bit. The compromised client 103 can transmit 1/RTTₘₐₓ bits per second. For the fixed time scheme, the compromised client 103 chooses a request interval based on the maximum RTT but not reflecting the maximum RTT to evade detection. At a fixed time of day, the compromised client 103 will begin sending or not sending DNS requests according to the selected interval. For the time-interval scheme, the compromised client 103 can transmit DNS requests at varying times with the timing of a sequence of DNS requests corresponding to an implied value. FIG. 1 depicts attempted data exfiltration according to a fixed time scheme, but the same defense technique can defeat encoding according to the time-interval scheme.

At stage B, the firewall 101 measures time intervals between DNS requests for the root domain example.com, including DNS requests to resolve subdomains, to determine minimum time intervals between DNS requests for example.com. The firewall 101 initially analyzes historical DNS traffic in traffic logs 109. The firewall 101 can supplement with in-line determinations to capture changes in behavior, either an ongoing determination for a new minimum or capturing minimum time intervals by time windows.

At stage C, the firewall 101 monitors DNS requests for *example.com with respect to the minimum time interval between DNS requests determined for example.com. The firewall 101 starts a timer after detection of each DNS request for *example.com.

A view 111 provides an example illustration of a small sample of the DNS request transmissions from the compromised client 103 and the interference by the firewall 101. The view 111 maps the bits being implicitly encoded by the compromised client 103 to the bits recorded by the attacker name server 105. Beginning at a fixed time tₙ, the compromised client transmits or does not transmit a DNS request every m seconds. It is presumed that m is greater than or equal to the minimum time interval that has been determined for example. com by the firewall.

At stage D, the firewall 101 detects when the minimum time interval expires without transmission of a DNS request for example. com and non-deterministically transmits a DNS request for example. com. At stage E, the attacker name server 105, records bits according to the timing of the DNS requests. At tₙ, the compromised client transmits a DNS request that is communicated to the attacker name server 105 (e.g., via a DNS resolver(s)) and the attacker name server 105 records “1”. At or prior to tₙ₊ₘ, the firewall 101 detects that the minimum time interval, tₘᵢₙ, expires without transmission of a DNS request. Based on a randomized function, the firewall 101 determines whether or not to transmit a DNS request. In this illustration, the firewall 101 does not transmit a DNS request based on output of the randomized function and resets the timer. Accordingly, the attacker name server 105 records a “0.” At or prior to tₙ₊₂ₘ, the firewall 101 again detects that tₘᵢₙ expires without transmission of a DNS request. Based on the randomized function, the firewall 101 transmits a DNS request. Accordingly, the attacker name server 105 records “1.” At tₙ₊₃ₘ, the compromised client transmits a DNS request that is communicated to the attacker name server 105 and the attacker name server 105 records “1”. Thus, the compromised client 103 has attempted to exfiltrate “1001” while the firewall 101 has injected noise into the timing channel that causes the attacker name server 105 to record “1011” instead.

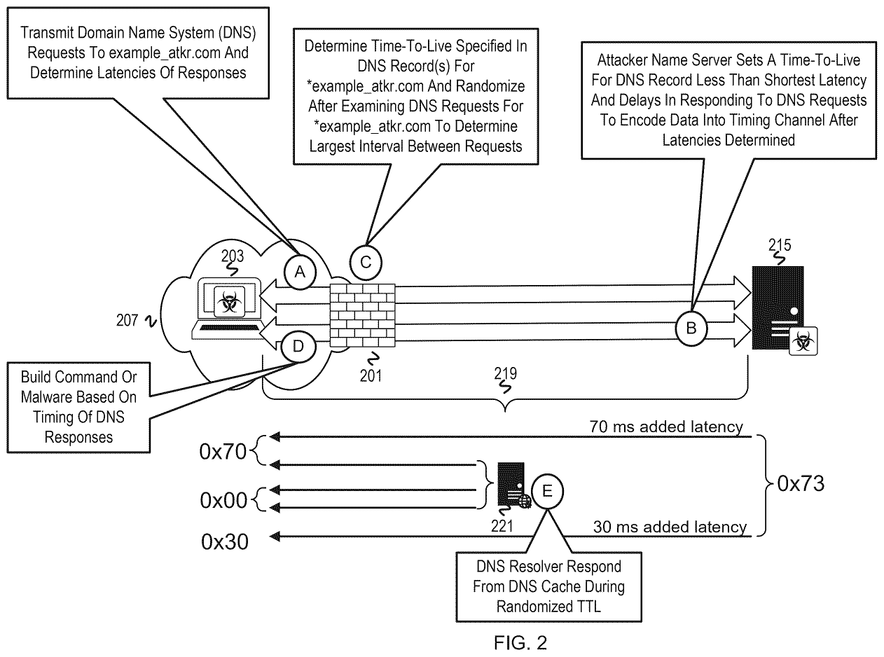

FIG. 2 is a diagram of a firewall defending against a timing-based DNS tunneling data infiltration attack. FIG. 2 depicts a compromised client 203 in a network 207 protected by a firewall 201. An attacker name server 215 for a root domain example_atkr.com is attempting to transmit C2 data to the compromised client 203.

FIG. 1 also includes a DNS resolver 221. The DNS resolver 221 can be co-located or co-hosted with the firewall 201 or downstream from the firewall 201 within the network 207. As with FIG. 1, this example illustration also presumes summarization by root name, but implementations can monitor by fully qualified domain name (FQDN).

FIG. 2 is annotated with a series of letters A-D representing stages of operations, each stage corresponding to one or more operations. Each stage encompasses multiple operations that can overlap in time with operations of other stages. Although these stages are ordered for this example, the stages illustrate one example to aid in understanding this disclosure and should not be used to limit the claims. Subject matter falling within the scope of the claims can vary from what is illustrated.

At stage A, the compromised client 203 and the attacker name server 215 interact to observe latencies of DNS responses from the attacker name server 215 for example_atkr.com. The attacker name server 215 can use either a fixed time encoding scheme that signals bits by responding and not responding or a latency encoding scheme. FIG. 2 illustrates the latency encoding scheme, but the defense against this infiltration attack can corrupt encoding in either scheme. The interactions are used to determine whether the network is sufficiently stable to support implicit encoding in the time channel for latency encoding. The interactions can also be used to determine timeouts of resolvers. With these temporal parameters determined, the attacker name server 215 and compromised client 203 determine the bits that can be encoded in timing of a DNS response.

At stage B, the attacker name server 215 sets a time-to-live in DNS records for DNS responses to DNS requests from the compromised client 203. The attacker name server 215 sets the TTL to a value that is less than the shortest latency that the attacker name server 215 will use to encode data. The attacker name server 215 delays in responds to each DNS request to encode data into the timing channel according to the temporal parameters for latency encoding determined from the observed latencies.

At stage C, the firewall 201 detects a DNS response for *example_atkr.com. The firewall 201 will have examined the request-response pairs for *example_atkr.com to determine a maximum interval between the DNS requests. After determining the maximum request interval for *example_atkr.com, the firewall 201 changes TTLs indicated in DNS records for *example_atkr.com. The firewall 201 generates a randomized TTL value that is greater than the maximum request interval determined for *example_atkr.com and sets the TTL in the DNS record to the generated TTL value.

A view 219 of a subset of transmissions from the attacker name server 215 provides an illustration of the injection of randomization into the timing channel to corrupt the data infiltration. The view 219 encompasses stages D and E. At stage D, the compromised client builds a command or malware based on the timing of DNS responses from the attacker name server 215. At stage E, the DNS resolver 221 responds from DNS cache during the randomized TTL. In the view 219, the attacker name server 215 will encode 0×73 by adding 70 milliseconds (ms) of latency to a first DNS response and then adding 30 ms of latency to a second DNS response. Assuming the compromised client 203 has observed latency of 10 ms, the compromised client will encode a “0” if a DNS response is received within 10 ms. When the compromised client 203 receives the first DNS response with 80 ms of latency, the compromised client 203 sets “7” for the 4 most significant bits. However, the firewall 201 overwrites the TTL in the DNS record of this first response. Thus, the DNS resolver 221 will respond to DNS requests during the randomized TTL from the DNS cache. In response to the second DNS request from the compromised client 203, the DNS resolver 221 responds without any additional latency which causes the compromised client 203 to record a “0”. The DNS resolver 221 responds two more times from the chase during the randomized TTL. For a fourth DNS request that is sent after the randomized TTL, the attacker name server 215 responds with 30 ms of added latency. Instead of the compromised client 203 recording 0×73, the comprised client has recorded 0×70, 0×00, and 0×30.

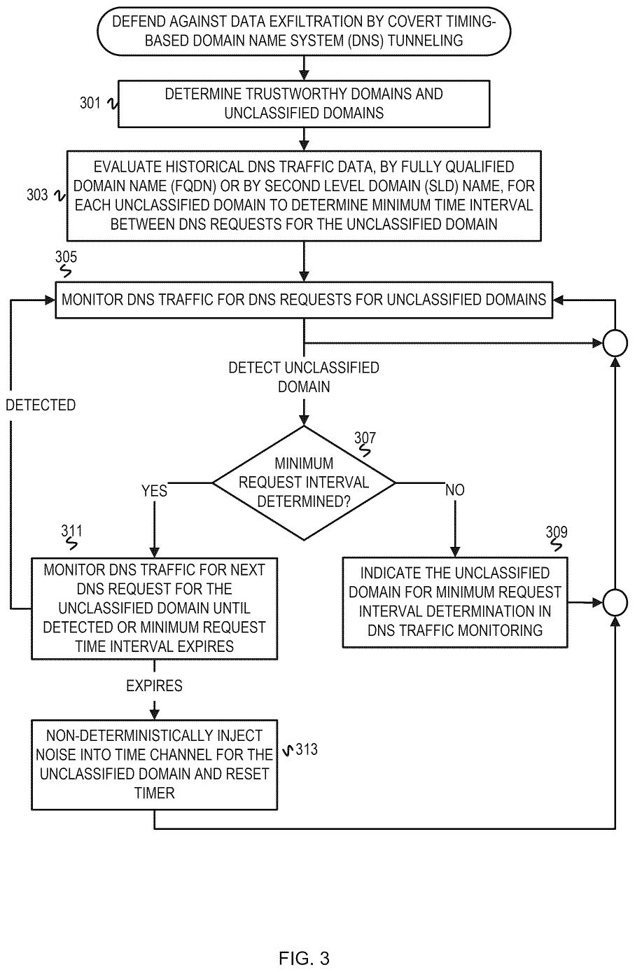

FIGS. 3-4, and 6 are flowcharts of example operations for defending against potential timing-based DNS tunneling attacks. The descriptions of these figures refer to a firewall, which can be a hardware security appliance, a virtual firewall, or a service (i.e., Firewall-as-a-Service (FWaaS)). Furthermore, other security entities can have the described functionality. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for defending against data exfiltration by covert timing-based DNS tunneling. While FIG. 1 depicted interaction between a single compromised client and a single attacker name server, a data exfiltration attack with the C2 technique can be more involved. Different compromised clients may be attempting to exfiltrate different data fragments that will be assembled after recreation of the fragments by the attacker name server. In addition, a malicious actor (e.g., nation state sponsored malicious actors) can coordinate exfiltration from multiple compromised clients with multiple name servers. Thus, the described example operations are not limited to individual sessions and can defeat exfiltration being carried out across multiple sessions.

At block 301, the firewall determines trustworthy domains and unclassified domains. Since the defense technique is monitoring for potential attacks with timing-based DNS tunneling, the scope of domains is reduced by eliminating from consideration or filtering out trustworthy domains. Some trustworthy domains are well-known and can be indicated in a list. Other domains can be determined from reputation scores obtained from website tracking sites that score reputation and/or popularity. Those with a minimum score reputation/popularity score can be deemed as trustworthy. Next, the firewall examines name servers of domains. For instance, the firewall identifies the name server of each FQDN not already indicated as trustworthy based on being reputable or popular. The firewall indicates each FQDN with a name server that is not susceptible to DNS tunneling. For example, the firewall determines whether a name server has a longstanding reputation or has been established for a minimum amount of time. Pre-filtering rules are created based on the specified trustworthy domains. The firewall does not necessarily determine which domains are trustworthy and create the pre-filtering rules. Instead, this can be determined offline with a cloud-based service or platform and compiled into the pre-filtering rules which are then indicated to the firewall. The domains not indicated in the pre-filtering rules are referred to as unclassified domains.

At block 303, the firewall evaluates historical DNS traffic data, by FQDN or root domain name, for each unclassified domain to determine a minimum time interval between DNS requests for the unclassified domain. The firewall applies the pre-filtering rules to identify unclassified domains. For each unclassified domain, the firewall then determines time intervals between successive DNS requests for the FQDN of the unclassified domain. If summarization is being implemented, the firewall can determine, for each unclassified domain, time intervals between DNS requests across domain names that include the root name. After a sufficient number of minimum time intervals, which can be configurable, have been determined, the minimum is selected for each FQDN or root domain name depending upon implementation. Again, the firewall does not necessarily examine historical DNS traffic data to determine the minimum time interval between DNS requests. This can be performed by a related service (e.g., DNS security) or software-defined wide area network (SD-WAN) component, for example.

At block 305, the firewall monitors DNS traffic for DNS requests for unclassified domains. The monitoring is in-line with respect to the DNS traffic and ongoing as indicated by flow returning to block 305 in FIG. 3. To monitor, the firewall applies the pre-filtering rules to determine whether a DNS request is for an unclassified domain. When an unclassified domain is detected in a DNS request, operational flow proceeds to block 307.

At block 307, the firewall determines whether a minimum request interval for the detected unclassified domain has been previously determined. If a minimum request interval for the detected unclassified domain has not been previously determined, then operational flow proceeds to block 309. Otherwise, operational flow proceeds to block 311.

At block 309, the firewall indicates the unclassified domain for minimum request interval determination in DNS traffic monitoring. Either the unclassified domain has not previously been detected for determination of the minimum time interval between requests or sufficient DNS requests have not been observed for collection of request time intervals. The firewall monitors the live DNS traffic to observe additional DNS requests for the unclassified domain and then determines a minimum request time interval. Operational flow returns to block 305.

At block 311, the firewall monitors DNS traffic for a next DNS request for the unclassified domain until a DNS request is detected or the minimum request time interval expires. After detecting the DNS request for the unclassified domain and determining the minimum request time interval, the firewall starts a timer for the unclassified domain. Depending upon implementation, the timer is started for a FQDN or a root domain name. If the next DNS request for the unclassified domain is detected prior to expiration of the minimum request time interval, then the timer is cancelled or reset and operational flow returns to block 305. If the minimum request time interval expires prior to detection of a next DNS request, then operational flow proceeds to block 313.

At block 313, the firewall non-deterministically injects noise into the time channel for the unclassified domain and resets the timer. To non-deterministically inject noise, the firewall uses a random or pseudo-random function to determine whether to transmit a DNS request. For instance, the firewall can employ a probability distribution for the two possibilities of injecting noise or not injecting noise at a time tᵢ. When a minimum time interval expires for an unclassified domain, the firewall invokes a cumulative distributive function based on preceding decisions back to tᵢ₋ₓ to determine whether or not to transmit a DNS request at tᵢ. The firewall will use the initially detected DNS request for the unclassified domain as a template for the DNS request that the firewall transmits. For instance, the firewall extracts request type and request name from the detected DNS request. Embodiments can also apply time decay to the randomized function to decrease the probability of injecting noise to reduce the chance of the disruption being detected by the attacker. Operational flow returns to block 305 where the monitoring was ongoing from block 313.

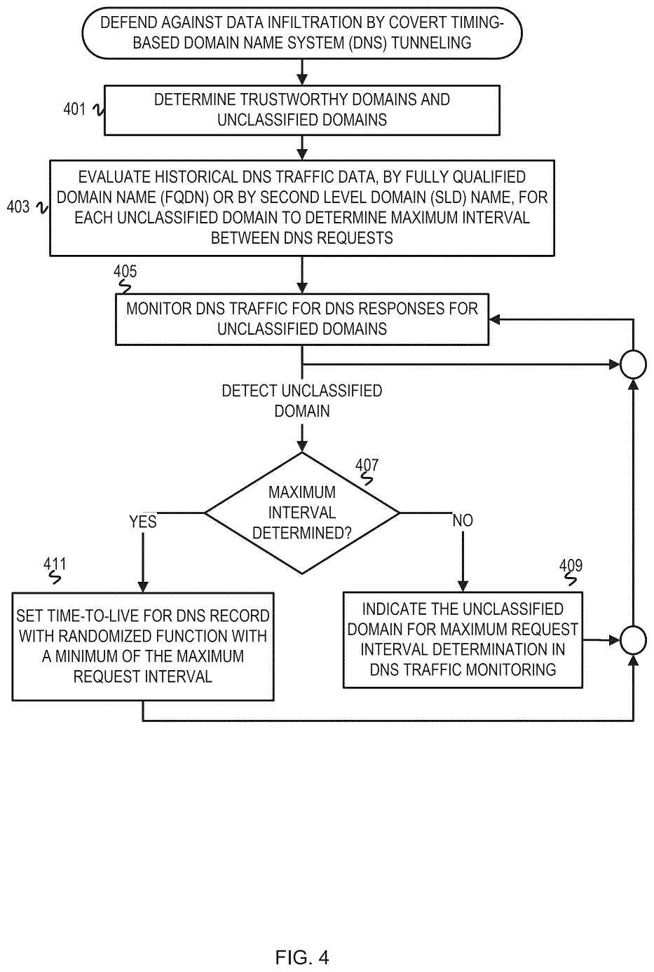

FIG. 4 is a flowchart of example operations for defending against data infiltration by covert timing-based DNS tunneling. FIG. 2 depicted interaction between a single compromised client and a single attacker name server. Similar to data exfiltration, a data infiltration attack with the C2 technique can use multiple compromised clients and/or multiple attack name servers. Accordingly, the example operations presume monitoring across sessions, and not limited to an individual session.

At block 401, the firewall determines trustworthy domains and unclassified domains. Similar to block 301, pre-filtering rules are generated to focus monitoring on the unclassified domains that can potentially be used in a DNS tunneling attack.

At block 403, the firewall evaluates historical DNS traffic data, by FQDN or by root domain name, for each unclassified domain to determine a maximum time interval between DNS requests for the unclassified domain. The firewall applies the pre-filtering rules to identify unclassified domains. For each unclassified domain, the firewall then determines time intervals between successive DNS requests for the FQDN of the unclassified domain. If summarization is implemented, the firewall can determine, for each unclassified domain, time intervals between DNS requests across domain names that include the root domain name. After a sufficient number of maximum time intervals have been determined, the maximum latency is selected for each FQDN or root domain name depending upon implementation.

At block 405, the firewall monitors DNS traffic for DNS responses for unclassified domains. The monitoring is in-line with respect to the DNS traffic and ongoing as indicated by flow returning to block 405 in FIG. 4. To monitor, the firewall applies the pre-filtering rules to determine whether a DNS response is for an unclassified domain. When an unclassified domain is detected in a DNS response, operational flow proceeds to block 407.

At block 407, the firewall determines whether a maximum request time interval for the detected unclassified domain has been previously determined. If a maximum request time interval for the detected unclassified domain has not been previously determined, then operational flow proceeds to block 409. Otherwise, operational flow proceeds to block 411.

At block 409, the firewall indicates the unclassified domain for maximum request time interval determination in DNS traffic monitoring. Either the unclassified domain has not previously been detected for determination of the maximum time interval between requests or sufficient DNS requests have not been observed for collection of request time intervals. The firewall monitors the live DNS traffic to observe additional DNS requests for the unclassified domain and then determines a maximum request time interval. Operational flow returns to block 405.

At block 411, the firewall sets a TTL for the DNS record of the detected unclassified domain in the DNS response. The firewall uses a randomized function to generate a TTL value. The firewall has parameterized the randomized function with a floor TTL value that corresponds to the maximum request time interval. Thus, a DNS cache will be used to respond to DNS requests during the TTL time period and corrupt any encoding that was relying on latency being controlled by the attacking name server.

The earlier examples described defending against DNS tunneling attacks that implicitly encode data in a covert time channel. However, the malicious actors are limited to registering domains that cannot be detected with existing malicious domain detection. When malicious actors employ relayed DNS tunneling, they evade detection that relies on examining DNS traffic. However, non-DNS traffic can be examined to defeat timing-based relayed DNS tunneling infiltration attacks. As noted previously, non-DNS traffic will have indicators of potential hidden resolution path triggers or relayed DNS tunneling triggers. Depending on the protocol, certain fields will have hostnames specified to trigger the relayed DNS tunneling. Knowledge of this attack surface guides examination of the non-DNS traffic. For HTTP, HTTPS, and HTTP/3, the host header field and either of Internet Protocol (IP) related header fields (e.g., X-Forward-For) and proxy related header fields (e.g., Forwarded) can be used to specify hostnames. For Transport Layer Security (TLS) and QUIC, a hostname can be specified in the Server Name Indication (SNI) field. And a hostname can be specified in either of the HELO and FROM fields in SMTP messages. Non-DNS traffic can be examined for potential abuse of these fields that are part of a relayed DNS tunneling attack surface.

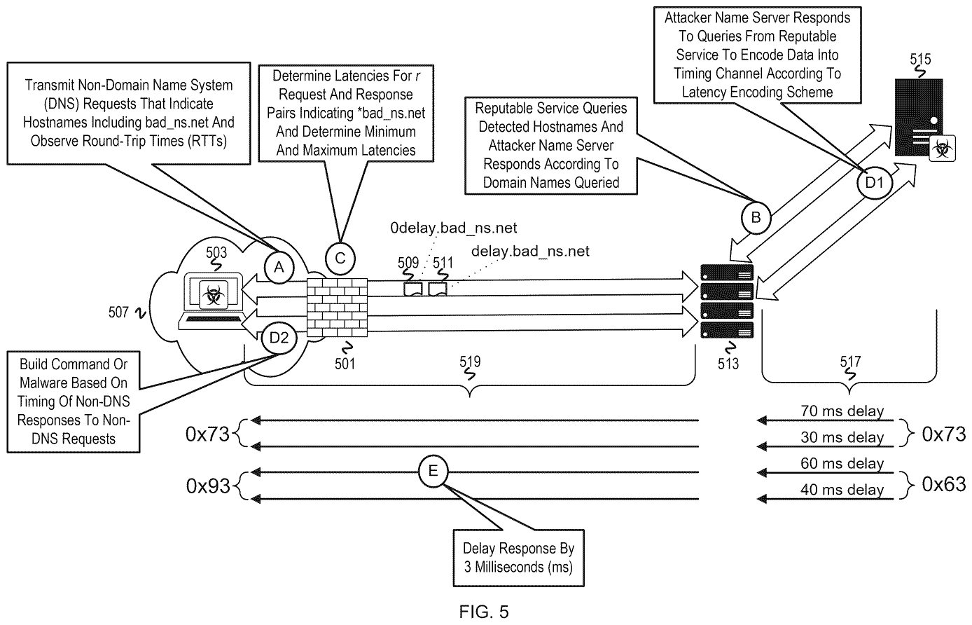

FIG. 5 is a diagram of a firewall defending against a timing-based relayed DNS tunneling data infiltration attack. A compromised client 503 is within a network 507 protected by a firewall 501. An attacker name server 515 for a root domain bad_ns.net is attempting to transmit C2 data implicitly encoded in a timing channel to the compromised client 503. As with the preceding diagrams, this example illustration presumes summarization by root name, but implementations can monitor by fully qualified domain name (FQDN).

FIG. 5 is annotated with a series of letters A-C, D1, D2, and E representing stages of operations, each stage corresponding to one or more operations. Each stage encompasses multiple operations that can overlap in time with operations of other stages. Although these stages are ordered for this example, the stages illustrate one example to aid in understanding this disclosure and should not be used to limit the claims. Subject matter falling within the scope of the claims can vary from what is illustrated.

At stages A and B, the compromised client 503 and the attacker name server 515 interact via a server 513 of a reputable service (e.g., content delivery network (CDN) service) to observe RTTs for pairs of non-DNS requests and responses. As indicated earlier, examples of the non-DNS traffic include electronic mail traffic and web traffic. At stage A, the compromised client 503 transmits non-DNS requests with hostnames embedded within the non-DNS requests. For this illustration, the compromised client 503 is sending non-DNS requests that indicate a hostname that includes bad_ns.net, for example in a header field that will be parsed by a reputable service that responds to the non-DNS request. At stage B, the server(s) 513 of a reputable service queries the attacker name server 515 for the hostnames *bad_ns.net detected when parsing the non-DNS requests from the compromised client 503. The attacker name server 515 responds according to the domain names that are queried. As the compromised client 503 and the attacker name server 515 are attempting to observe the bounds of latencies, the compromised client 503 uses predefined hostnames that instruct the attacker name server 515 to either respond without delay or not respond to cause a maximum latency. In FIG. 5, the compromised client 503 signals to the attacker name server 515 to respond by using the hostname 0delay.bad_ns.net in a non-DNS request 509. In a non-DNS request 511, the compromised client 503 signals to the attacker name server 515 to not respond with the hostname delay.bad_ns.net.

At stage C, the firewall 501 determines latencies observed for r request and response pairs in non-DNS traffic that indicates hostnames *bad_ns.net. The threshold r for sufficient request and response pairs can be configured to ensure sufficient samples for statistical analysis in determining maximum and minimum latencies for responses to the non-DNS requests from the compromised client 503.

At stage D1, the compromised client 503 sends non-DNS requests that include the hostname bad_ns.net and the attacker name server 515 responds to DNS queries from the reputable server 513 triggered from parsing the non-DNS requests. The attacker name server 515 responds without delay or with varying delay to encode data into the timing channel according to the latency encoding scheme and determined encoding parameters.

At stage D2, the compromised client 503 builds or assembles a command or malware based on the timing of the non-DNS responses to the non-DNS requests.

Decoding the timing of the non-DNS responses by the compromised client 503 will be according to the encoding parameters determined from the RTTs observed during the observation interactions in stage A.

A view 517 of a subset of transmissions from the attacker name server 515 provides an illustration of the implicit encoding attempted by the attacker name server 515 with manipulation of delay. A view 519 of a subset of transmissions from the reputable server 513 correspond to those in the view 517 and depict injection of randomization by the firewall 501. Together, these views 517, 519 provide an illustration of the injection of randomization into the timing channel to corrupt the data infiltration attempted with relayed DNS tunneling. The view 517 corresponds to stage D1 and the view 519 corresponds to stage D2 and includes the stage E. In the view 517, the attacker name server 515 responds to 4 queries from the reputable server 513 with added latencies of 70 ms, 30 ms, 60 ms, and 40 ms. Assuming an encoding scheme with 10 ms windows and no delay being 10 ms or less, then the attacker name server 515 is encoding across the timing of the 4 DNS responses to the reputable server the two values 0×73 and 0×63. For each response to a non-DNS request that indicated *bad_ns.net, the firewall will use a randomized function to determine an amount of delay to inject. At stage E, the firewall determines that the third response will be delayed an additional 3 ms. Accordingly, the compromised client 503 decodes the timing of the responses to build the values 0×73 and 0×93 instead of the values intended by the attacking name server.

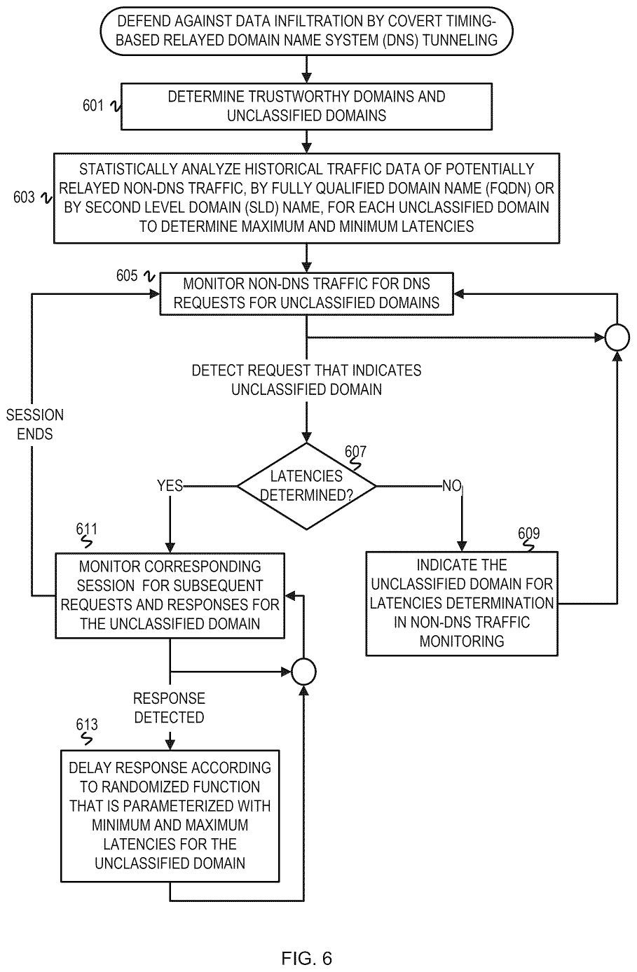

FIG. 6 is a flowchart of example operations for defending against data infiltration by covert timing-based relayed DNS tunneling. While the attack can be complex as mentioned for the previous flowcharts and involve other participants, the leveraging of a reputable service imposes some limitations. With the requests being non-DNS requests and responses that can extend over multiple packets, data infiltrations relying on latency encoding when attacking with relayed DNS tunneling may be constrained to an application layer session or constrained to multiple sessions across compromised devices indirectly interacting with a same attacker name server{. The example operations of FIG. 6 describe operations that analyze per session after detection of a non-DNS request for an unclassified domain.

At block 601, the firewall determines trustworthy domains and unclassified domains. Similar to blocks 301 and 401, pre-filtering rules are generated to focus monitoring on the unclassified domains that can potentially be used to trigger relayed DNS tunneling.

At block 603, the firewall statistically analyzes historical non-DNS traffic data, by FQDN or by root domain name, for each unclassified domain to determine maximum and minimum latencies of non-DNS responses for the unclassified domain. The firewall applies the pre-filtering rules to identify unclassified domains. For each unclassified domain, the firewall then determines RTTs for a statistically sufficient amount of request response pairs. The firewall uses the RTTs to capture the time for the hidden resolution path. The firewall determines the minimum RTT and the maximum RTT. The firewall can use the maximum RTT as an observable maximum latency and the minimum RTT as an observable minimum latency.

At block 605, the firewall monitors non-DNS traffic for non-DNS requests for the unclassified domains. The monitoring is in-line with respect to the non-DNS traffic and ongoing as indicated by flow returning to block 605 in FIG. 6. To monitor, the firewall selects non-DNS requests of protocols that are susceptible to relayed DNS tunneling. The firewall then examines the header fields of the selected non-DNS requests and applies the pre-filtering rules to determine whether a non-DNS request is for an unclassified domain. When an unclassified domain is detected in a selected non-DNS request, operational flow proceeds to block 607.

At block 607, the firewall determines whether observable minimum and maximum latencies have been determined for the detected unclassified domain. If the observable latencies for the detected unclassified domain have not been previously determined, then operational flow proceeds to block 609. Otherwise, operational flow proceeds to block 611.

At block 609, the firewall indicates the unclassified domain for observable latencies determination in DNS traffic monitoring. Either the unclassified domain has not previously been detected for determination of the latencies or sufficient non-DNS request-response pairs have not been observed for statistical analysis. The firewall monitors the live non-DNS traffic to observe additional non-DNS request-response pairs for the unclassified domain and then determines the observable minimum and maximum latencies. Operational flow returns to block 605.

At block 611, the firewall monitors a session of the protocol of the non-DNS request for subsequent requests and responses for the unclassified domain until the session ends. This ongoing monitoring is represented by the arrow returning to block 611 until the session ends. When the session ends, operational flow returns to block 605. When a response to a previously detected non-DNS request is detected, operational flow proceeds to block 613.

At block 613, the firewall delays the non-DNS response according to a randomized function parameterized with the minimum and maximum latencies. The randomized function is parameterized to generate a randomized value to be applied in delaying a non-DNS response. The maximum and minimum latencies are used as parameters to constrain generation to a randomized value that is greater than the minimum latency and less than the maximum latency. For instance, the firewall can determine to delay a response to a i^{th} request transmitted at tᵢ until tᵢ+kᵢ*latencyₘᵢₙ, where k is a tunable factor that varies with i and satisfies kᵢ*latencyₘᵢₙ<latencyₘₐₓ. Embodiments can also use a probability function that generates a probability pᵢ to determine whether or not to inject additional latency for the response to the ith non-DNS request. Operational flow returns to block 611.

### Variations

The example operations for defeating data infiltration that uses relayed DNS tunneling referred to per session analysis after detection of a request to an unclassified domain. However, embodiments are not so limited. Embodiments can analyze based on a session agnostic view of request-response pairs to a domain that has not been filtered out from DNS tunneling attack defense. A firewall that implements the disclosed technology can apply the delay to responses regardless of session for each unclassified domain. Determining whether or not to delay will be applied across request-response pairs without regard to session. Moreover, multiple firewalls or traffic monitoring points of a network can aggregate their views of non-DNS traffic to unclassified domains and apply the delaying response defense across the multiple monitoring points. For example, the multiple monitoring points or firewalls may share observed latencies across points and determine the maximum and minimum latencies from a global perspective instead of a local perspective.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

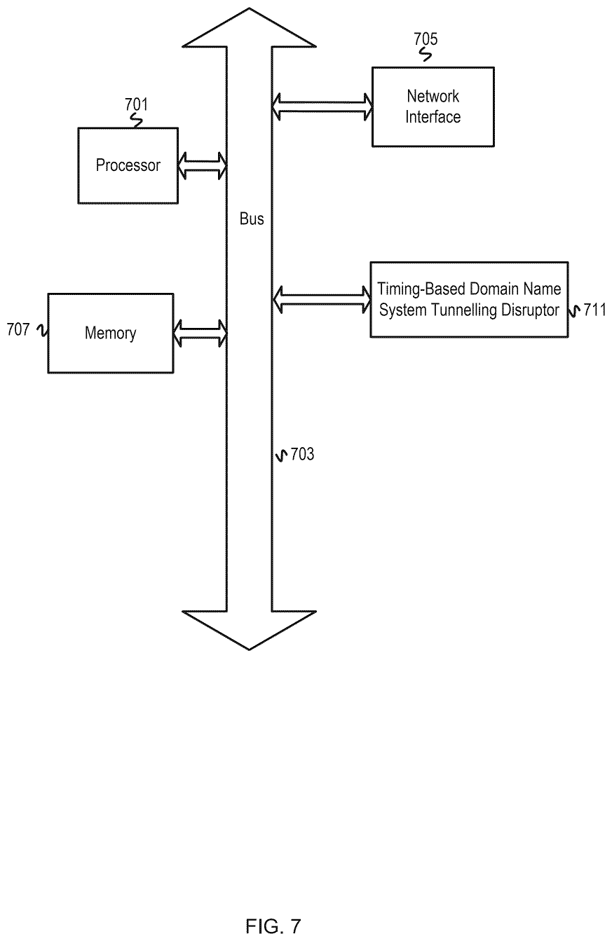

FIG. 7 depicts an example computer system with security against timing-based DNS tunneling attacks. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes security against timing-based DNS tunneling attacks (“DNS tunneling disruptor”) 711. The DNS tunneling disruptor 711 can implement one or more of the disclosed defense techniques against timing-based tunneling attacks, whether relayed or not relayed. For instance, the timing-based DNS tunneling disruptor 711 can monitor DNS traffic in-line and defend against timing-based DNS tunneling exfiltration attacks and monitor non-DNS traffic in-line and defend against timing-based relayed DNS tunneling attacks. As previously mentioned, another device or component, such as a cloud-based service or SD-WAN element, can analyze historical traffic data to determine the relevant timing parameters (e.g., maximum request time intervals of DNS requests and/or minimum and maximum latencies of non-DNS request-response pairs) and provide that information to the timing-based DNS tunneling disruptor 711. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
identifying domains susceptible to DNS tunneling in domain name server (DNS) requests in observed DNS traffic;
for each of the identified domains, determining a minimum of time intervals between DNS requests corresponding to the identified domain;
disrupting potential data exfiltration by timing-based DNS tunneling, wherein the disrupting comprises,
monitoring DNS traffic for DNS requests corresponding to the identified domains;
based on detection of a first DNS request for a first of the identified domains while monitoring the DNS traffic,
after the first DNS request, determining whether a next DNS request for the first domain is detected before the minimum time interval for the first domain expires or the minimum time interval determined for the first domain expires; and
based on determining that the minimum time interval for the first domain expires, non-deterministically determining whether to inject a next DNS request for the first domain and injecting according to the non-deterministic determination.

2. The method of claim 1, wherein identifying domains susceptible to DNS tunneling comprises filtering out trustworthy domains.

3. The method of claim 2, wherein filtering out trustworthy domains comprises filtering domains based on reputation and popularity and filtering out domains with name servers that are known.

4. The method of claim 1, wherein determining a minimum of time intervals between DNS requests corresponding to each identified domain comprises distinguishing DNS requests either by fully qualified domain name or root domain name.

5. The method of claim 1, wherein non-deterministically determining whether to inject a next DNS request for the first domain comprises obtaining a value from a probability function at each expiration of the minimum time interval for the first domain after detection of a DNS request for the first domain, wherein the non-deterministic determination is based on the probability value.

6. The method of claim 1 further comprising recording a request name and request type from the first DNS request for the first domain, wherein injecting the next DNS request comprises creating the next DNS request with the recorded request name and request type.

7. The method of claim 1 further comprising disrupting potential malicious data infiltration by timing-based DNS tunneling, wherein disrupting potential malicious data infiltration comprises:
for each identified domain,
detecting a first DNS response to a second DNS request corresponding to a second of the identified domains;
generating a randomized time-to-live (TTL) value; and
setting the TTL in a DNS record of the first DNS response to the randomized TTL value.

8. The method of claim 7 further comprising, for each of the identified domains, determining a maximum of time intervals between DNS requests corresponding to the identified domain, wherein the randomized TTL value is generated to at least be the maximum time interval determined for the second domain.

9. A non-transitory, machine-readable medium having stored therein program code comprising instructions to:
identify domains susceptible to domain name server (DNS) tunneling in DNS requests in observed DNS traffic;
for each of the identified domains, determine a minimum of time intervals between DNS requests corresponding to the identified domain;
monitor DNS traffic for DNS requests corresponding to the identified domains;
based on detection of a first DNS request for a first of the identified domains while monitoring the DNS traffic,
monitor the DNS traffic to determine whether a next DNS request for the first identified domain is detected prior to expiration of the minimum time interval for the first identified domain; and
based on a determination that the minimum time interval for the first identified domain expires prior to detection of a next DNS request for the first identified domain, non-deterministically determine whether to transmit a next DNS request for the first identified domain and generate and transmit a next DNS request for the first identified domain according to the non-deterministic determination.

10. The non-transitory, machine-readable medium of claim 9, wherein the instructions to identify domains susceptible to DNS tunneling comprise instructions to filter out trustworthy domains.

11. The non-transitory, machine-readable medium of claim 10, wherein the instructions to filter out trustworthy domains comprise instructions to filter domains based on reputation and popularity and based on name server.

12. The non-transitory, machine-readable medium of claim 9, wherein the instructions to determine a minimum of time intervals between DNS requests corresponding to each identified domain comprise instructions to distinguish DNS requests either by fully qualified domain name or root domain name.

13. The non-transitory, machine-readable medium of claim 9, wherein the instructions to non-deterministically determine whether to transmit a next DNS request for the first identified domain comprise instructions to obtain a value from a probability function at each expiration of the minimum time interval for the first identified domain, wherein the non-deterministic determination is based on the probability value.

14. The non-transitory, machine-readable medium of claim 9, wherein the program code further comprises instructions to record a request name and request type from the first DNS request for the first identified domain when detected, wherein the instructions to generate the next DNS request for the first identified domain comprise instructions to generate the next DNS request with the recorded request name and request type.

15. The non-transitory, machine-readable medium of claim 9, wherein the program code further comprises instructions to disrupt potential data infiltration by timing-based DNS tunneling, wherein the instructions to disrupt potential data infiltration comprise instructions to:
for each identified domain,
detect a first DNS response to a second DNS request corresponding to a second of the identified domains;
generate a randomized time-to-live (TTL) value; and
set the TTL in a DNS record of the first DNS response to the randomized TTL value.

16. The non-transitory, machine-readable medium of claim 15, wherein the program code further comprises instructions to, for each of the identified domains, determine a maximum of time intervals between DNS requests corresponding to the identified domain, wherein the randomized TTL value is generated to at least be the maximum time interval determined for the second identified domain.

17. An apparatus comprising:
a processor; and
a machine-readable medium having stored therein instructions executable by the processor to cause the apparatus to,
identify domains susceptible to DNS tunneling in domain name server (DNS) requests in observed DNS traffic;
for each of the identified domains, determine a minimum of time intervals between DNS requests corresponding to the identified domain;
monitor DNS traffic for DNS requests corresponding to the identified domains;
based on detection of a first DNS request for a first of the identified domains while monitoring the DNS traffic,
monitor the DNS traffic to determine whether a next DNS request for the first identified domain is detected prior to expiration of the minimum time interval for the first identified domain; and
based on a determination that the minimum time interval for the first identified domain expires prior to detection of a next DNS request for the first identified domain, non-deterministically determine whether to transmit a next DNS request for the first identified domain and generate and transmit a next DNS request for the first identified domain according to the non-deterministic determination.

18. The apparatus of claim 17, wherein the instructions to determine a minimum of time intervals between DNS requests corresponding to each identified domain comprise instructions executable by the processor to cause the apparatus to distinguish DNS requests either by fully qualified domain name or root domain name.

19. The apparatus of claim 17, wherein the instructions to non-deterministically determine whether to transmit a next DNS request for the first identified domain comprise instructions executable by the processor to cause the apparatus to obtain a value from a probability function at each expiration of the minimum time interval for the first identified domain, wherein the non-deterministic determination is based on the probability value.

20. The apparatus of claim 17, wherein the machine-readable medium further comprises instructions executable by the processor to cause the apparatus to disrupt potential data infiltration by timing-based DNS tunneling, wherein the instructions to disrupt potential data infiltration comprise instructions executable by the processor to cause the apparatus to:
for each identified domain,
detect a first DNS response to a second DNS request corresponding to a second of the identified domains;
generate a randomized time-to-live (TTL) value; and
set the TTL in a DNS record of the first DNS response to the randomized TTL value.
